(19) United States
(12) Patent Application Publication
(10) Pub. No.: US 2024/0350233 A1
(43) Pub. Date: Oct. 24, 2024

(54) ORTHODONTIC DEVICE

(71) Applicant: AADvance Technologies, LLC, San Diego, CA (US)

(72) Inventors: Kami Hoss, San Diego, CA (US); Steven Howard, La Jolla, CA (US); Jacob A. Moebius, Solana Beach, CA (US)

(21) Appl. No.: 18/762,591

(22) Filed: Jul. 2, 2024

Related U.S. Application Data
(63) Continuation of application No. PCT/US2023/010009, filed on Jan. 2, 2023.
(60) Provisional application No. 63/266,356, filed on Jan. 3, 2022.

(51) Int. Cl. A61C 7/28

(52) U.S. Cl. CPC A61C 7/287

(57) ABSTRACT

An orthodontic device can include a bracket configured to support an orthodontic wire. The orthodontic device can include a locking assembly coupled to the bracket and switchable between a plurality of operational modes. The plurality of operational modes can comprise a first sliding mode in which the orthodontic wire is slidable relative to the bracket and a second locked mode in which the orthodontic wire is slidably locked relative to the bracket.

### CROSS-REFERENCE TO RELATED APPLICATIONS

The present application is a continuation of International Application No. PCT/US2023/010009, filed on Jan. 2, 2023, which claims priority to U.S. Provisional Patent Application No. 63/266,356, filed Jan. 3, 2022, the entire contents of each of which are incorporated by reference in their entirety and for all purposes.

### BACKGROUND

### Field

The field relates to an orthodontic device.

### Description of the Related Art

Orthodontic braces devices are used to correct dental malocclusion, which can generally be described as an abnormal alignment of a patient's teeth and/or the manner in which the upper and lower teeth fit together. Dental malocclusion is a significant problem in dental public health because of its adverse effects on teeth, bone, muscles, and/or nerve tissue. In addition to preventing or reducing physical discomfort, infection, and/or injury to maxillofacial tissues, braces or other orthodontic devices are often used to improve a patient's dental aesthetics. In orthodontic braces devices, a bracket is attached to a tooth, and an orthodontic wire (e.g., an archwire) is inserted into a wire retention cavity of the bracket. In traditional devices, ligatures (for example, elastic bands or steel ligatures) are used secure the wire to the bracket. In self-ligating devices, a wire can be inserted into the bracket and secured mechanically without using ligatures. In both traditional and self-ligating devices, the wire slides laterally relative to the bracket.

Current traditional and self-ligating orthodontic devices are applied and adjusted over numerous treatment appointments with the clinician. Such devices may be used for many months or years and may be painful to the patient. Moreover, current orthodontic devices can create unpredictable, unsustained quality of outcomes, as well as poor aesthetics due to the visibility of the braces. In some cases, a clinician can make an adjustment to the braces to align one tooth, which can undesirably induce misalignments in other teeth. Accordingly, there remains a continuing need for improved orthodontic devices.

### SUMMARY

In one embodiment, an orthodontic device is disclosed. The orthodontic device can include a bracket having a retention cavity sized and shaped to receive and support an orthodontic wire. The orthodontic device can include a clip to be coupled to the bracket and to be positioned over the orthodontic wire in use, the clip configured to move along a first direction to retain the orthodontic wire in the retention cavity. The orthodontic device can include a wedge member to be coupled to the bracket, the wedge member configured to move along a second direction, the second direction non-parallel relative to the first direction. The orthodontic device can further include a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

In some embodiments, the orthodontic wire is to be disposed between the wedge member and the clip with the wedge member disposed between the orthodontic wire and the bracket, the wedge member including a tapered wedge surface that engages the orthodontic wire.

In some embodiments, the frictional adjustment mechanism is adjustable to apply a continuously variable frictional force against the orthodontic wire.

In some embodiments, movement of the wedge member is not configured to cause movement of the clip, and wherein movement of the clip is not configured to cause movement of the wedge member.

In some embodiments, the orthodontic device above further comprises the orthodontic wire.

In some embodiments, the frictional adjustment mechanism is configured to exert a non-sliding force against the orthodontic wire to prevent sliding that is at least 50 cN.

In some embodiments, the frictional adjustment mechanism is configured to exert a non-sliding force against the orthodontic wire to prevent sliding that is in a range of 100 cN to 2000 cN.

In some embodiments, the wedge member includes one or a plurality of tooling apertures sized to receive a tool to adjust the frictional force against the orthodontic wire.

In some embodiments, the frictional adjustment mechanism comprises the clip and the wedge member that cooperate to exert the adjustable frictional force against the orthodontic wire.

In some embodiments, in use, the orthodontic wire is to be disposed between the wedge member and the clip with the wedge member disposed between the orthodontic wire and the bracket.

In some embodiments, in use, the orthodontic wire is to be disposed between the bracket and the wedge member, the wedge member disposed between the wire and the clip.

In some embodiments, the wedge member includes a tapered wedge surface that engages the orthodontic wire, the wedge member having a thickness varying along at least a portion of the length of the wedge member.

In some embodiments, the clip, the wedge member, and the bracket are configured to cooperate to exert the adjustable frictional force against the orthodontic wire. The retention cavity extends along a lateral axis of the orthodontic device, the orthodontic device having a transverse axis perpendicular to the lateral axis. The wedge member has a tapered wedge surface angled relative to a vertical axis that is non-parallel relative to the lateral axis and the transverse axis, the wedge member having a thickness in the direction of the vertical axis and a length in the direction of the transverse axis, the thickness varying along at least a portion of the length of the wedge member.

In some embodiments, the clip, the wedge member, and the bracket are configured to cooperate to move between a plurality of operational modes, the plurality of operational modes comprises a first sliding mode in which the orthodontic wire is slidable relative to the bracket and a second locked mode in which the orthodontic wire is slidably locked relative to the bracket.

In some embodiments, in the first sliding mode, the clip is configured to be positioned over the orthodontic wire to retain the orthodontic wire in the retention cavity of the bracket.

In some embodiments, the wedge member in the sliding mode is disposed at a first position, and wherein the wedge member in the second locked mode is disposed at a second position that is different from the first position.

In some embodiments, in the second locked mode, the tapered wedge surface of the wedge member contacts and exerts a locking force against the orthodontic wire.

In some embodiments, in the second locked mode, the orthodontic wire is disposed between the clip and the wedge member, the wedge member and the clip cooperating to clamp the orthodontic wire.

In some embodiments, in the second locked mode, the orthodontic wire is disposed between the bracket and the wedge member, the wedge member disposed between the wire and the clip.

In another embodiment, an orthodontic device is disclosed. The orthodontic device can include a bracket having a retention cavity sized and shaped to receive and support an orthodontic wire, the retention cavity extending along a lateral axis of the orthodontic device, the orthodontic device having a transverse axis perpendicular to the lateral axis and a vertical axis perpendicular to the lateral and transverse axes. The orthodontic device can include a clip to be coupled to the bracket and to be positioned over the orthodontic wire in use, the clip configured to move along a first direction at a first angle relative to the transverse axis of the orthodontic device to retain the orthodontic wire in the retention cavity. The orthodontic device can include a wedge member to be coupled to the bracket, the wedge member configured to move along a second direction at a second angle relative to the transverse axis, the second angle different from the first angle. The orthodontic device can also include a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

In some embodiments, the first angle is not zero.

In some embodiments, the second angle is not zero.

In some embodiments, the orthodontic wire is to be disposed between the wedge member and the clip with the wedge member disposed between the orthodontic wire and the bracket, the wedge member including a tapered wedge surface that engages the orthodontic wire.

In some embodiments, the frictional adjustment mechanism is adjustable to apply a continuously variable frictional force against the orthodontic wire.

In some embodiments, movement of the wedge member is not configured to cause movement of the clip, and wherein movement of the clip is not configured to cause movement of the wedge member.

In some embodiments, the orthodontic device further comprises the orthodontic wire.

In some embodiments, the wedge member is configured to exert a non-sliding force against the orthodontic wire to prevent sliding that is at least 50 cN.

In some embodiments, the wedge member is configured to exert a non-sliding force against the orthodontic wire to prevent sliding that is in a range of 100 cN to 2000 cN.

In some embodiments, the wedge member includes one or a plurality of tooling apertures sized to receive a tool to adjust the frictional force against the orthodontic wire.

In some embodiments, the frictional adjustment mechanism comprises the clip and the wedge member that cooperate to exert the adjustable frictional force against the orthodontic wire.

In some embodiments, in use, the orthodontic wire is to be disposed between the wedge member and the clip with the wedge member disposed between the orthodontic wire and the bracket.

In some embodiments, in use, the orthodontic wire is to be disposed between the bracket and the wedge member, the wedge member disposed between the wire and the clip.

In some embodiments, the wedge member includes a tapered wedge surface that engages the orthodontic wire, the wedge member having a thickness varying along at least a portion of the length of the wedge member.

In some embodiments, the clip, the wedge member, and the bracket are configured to cooperate to exert the adjustable frictional force against the orthodontic wire. The wedge member has a tapered wedge surface angled relative to a vertical axis that is non-parallel relative to the lateral axis and the transverse axis, the wedge member having a thickness in the direction of the vertical axis and a length in the direction of the transverse axis, the thickness varying along at least a portion of the length of the wedge member.

In some embodiments, the clip, the wedge member, and the bracket are configured to cooperate to move between a plurality of operational modes, the plurality of operational modes comprises a first sliding mode in which the orthodontic wire is slidable relative to the bracket and a second locked mode in which the orthodontic wire is slidably locked relative to the bracket.

In some embodiments, in the first sliding mode, the clip is configured to be positioned over the orthodontic wire to retain the orthodontic wire in the retention cavity of the bracket.

In some embodiments, the wedge member in the sliding mode is disposed at a first position, and wherein the wedge member in the second locked mode is disposed at a second position that is different from the first position.

In some embodiments, in the second locked mode, the tapered wedge surface of the wedge member contacts and exerts a locking force against the orthodontic wire.

In some embodiments, in the second locked mode, the orthodontic wire is disposed between the clip and the wedge member, the wedge member and the clip cooperating to clamp the orthodontic wire.

In some embodiments, in the second locked mode, the orthodontic wire is disposed between the bracket and the wedge member, the wedge member disposed between the wire and the clip.

In another embodiment, a method of orthodontic treatment is disclosed. The method of orthodontic treatment can include securing an orthodontic device to a tooth, the orthodontic device comprising a wedge member. The method of orthodontic treatment can include adjusting the orthodontic device to exert a sliding frictional force against an orthodontic wire such that the orthodontic wire is slidable relative to the orthodontic device at an angle relative to a lateral axis of the orthodontic device, a non-sliding frictional force against the orthodontic wire that prevents sliding of the orthodontic wire relative to the orthodontic device, wherein adjusting the orthodontic device comprises moving the wedge member at an angle relative to a transverse axis non-parallel relative to the lateral axis.

In some embodiments, the method of orthodontic treatment can further comprises adjusting the orthodontic device to apply a continuously variable frictional force against the orthodontic wire.

In some embodiments, adjusting the orthodontic device further comprising moving a clip configured to cooperate with the wedge member to exert the adjustable frictional force against the orthodontic wire, wherein the clip is configured to be movable at an angle relative to the transverse axis.

In some embodiments, adjusting the orthodontic device further comprising moving a clip and a bracket configured to cooperate with the wedge member to exert the adjustable frictional force against the orthodontic wire, wherein the clip is configured to be movable at an angle relative to the transverse axis.

In some embodiments, the wedge member includes a tapered wedge surface that engages the orthodontic wire, the wedge member having a thickness varying along at least a portion of the length of the wedge member.

In some embodiments, adjusting the orthodontic device to exert the non-sliding frictional force comprises moving the wedge member at an angle relative to the transverse axis to cause the tapered wedge surface to engage with the orthodontic wire to exert the non-sliding force against the orthodontic wire.

In some embodiments, the clip, the wedge member, and the bracket are configured to cooperate to move between a plurality of operational modes, the plurality of operational modes comprises a first sliding mode in which the orthodontic wire is slidable relative to the bracket and a second locked mode in which the orthodontic wire is slidably locked relative to the bracket.

In some embodiments, the first sliding mode comprises positioning the clip over the orthodontic wire to retain the orthodontic wire in the retention cavity of the bracket.

In some embodiments, the first sliding mode comprises disposing the wedge member at a first position, and wherein the second locked mode comprises disposing the wedge member at a second position that is different from the first position.

In some embodiments, the second locked mode comprises moving the wedge member to have the tapered wedge surface of the wedge member contact and exert a locking force against the orthodontic wire.

In some embodiments, the second locked mode comprises disposing the orthodontic wire between the clip and the wedge member, cooperating the wedge member and the clip to clamp the orthodontic wire.

In some embodiments, the second locked mode comprises disposing the orthodontic wire between the bracket and the wedge member and disposing the wedge member between the wire and the clip.

In another embodiment, an orthodontic device is disclosed. The orthodontic device can include a bracket having a retention cavity sized and shaped to receive and support an orthodontic wire, the bracket having a base portion to be attached to a tooth to be treated, the base portion having first and second connecting side edges disposed at a non-orthogonal angle relative to one another. The orthodontic device can include a clip to be coupled to the bracket and to be positioned over the orthodontic wire in use, the clip configured to move along a first direction to retain the orthodontic wire in the retention cavity. The orthodontic device can include a wedge member to be coupled to the bracket, the wedge member configured to move along a second direction. The orthodontic device can include a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

In some embodiments, the first direction is non-parallel to the second direction.

In another embodiment, an orthodontic device is disclosed. The orthodontic device can include a bracket having a retention cavity sized and shaped to receive and support an orthodontic wire, the retention cavity extending along a lateral axis of the orthodontic device, the bracket having a base portion to be attached to a tooth to be treated along an attachment surface, the lateral axis non-parallel with the attachment surface. The orthodontic device can include a clip to be coupled to the bracket and to be positioned over the orthodontic wire in use, the clip configured to move along a first direction to retain the orthodontic wire in the retention cavity. The orthodontic device can include a wedge member to be coupled to the bracket, the wedge member configured to move along a second direction. The orthodontic device can include a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

In some embodiments, the first direction is non-parallel to the second direction.

For purposes of this summary, certain aspects, advantages, and novel features of certain disclosed inventions are summarized. It is to be understood that not necessarily all such advantages may be achieved in accordance with any particular embodiment of the invention. Thus, for example, those skilled in the art will recognize that the inventions disclosed herein may be embodied or carried out in a manner that achieves one advantage or group of advantages as taught herein without necessarily achieving other advantages as may be taught or suggested herein. Further, the foregoing is intended to summarize certain disclosed inventions and is not intended to limit the scope of the inventions disclosed herein.

### BRIEF DESCRIPTION OF THE DRAWINGS

FIG. 1A is a schematic side view of a tooth to be treated using an orthodontic treatment device, in which an orthodontic tension force is applied to move the tooth laterally in a horizontal direction.

FIG. 1B is a schematic side view of a tooth to be treated using an orthodontic treatment device, in which a tension force is applied to impart a torque load to rotate the tooth.

FIG. 2A is a schematic front, top, right side perspective view of an orthodontic device, according to one embodiment.

FIG. 2B is a schematic rear, top, left perspective view of the device of FIG. 2A.

FIG. 2C is a schematic top plan view of the device of FIGS. 2A-2B in a sliding support mode.

FIG. 2D is a schematic top plan view of the device of FIGS. 2A-2B in a locked support mode.

FIG. 2E is a schematic front, top, right side perspective view of a wedge member of the device of FIGS. 2A-2D.

FIG. 2F is a schematic rear, bottom, left side perspective view of the wedge member of FIG. 2E.

FIG. 2G is a schematic front, top, right side perspective view of a clip used in the device of FIGS. 2A-2D.

FIG. 2H is a schematic rear, bottom, left side perspective view of the clip of FIG. 2G.

FIG. 2I is a schematic front, top, left side perspective view of a bracket used in the device of FIGS. 2A-2D.

FIG. 2J is a schematic rear, right side perspective view of the bracket of FIG. 2I.

FIG. 2K is a schematic side sectional view of the orthodontic device of FIGS. 2A-2D in an open support mode, taken along section A-A of FIGS. 2C-2D.

FIG. 2L is a schematic side sectional view of the orthodontic device of FIGS. 2A-2D in a sliding support mode, taken along section A-A of FIG. 2C.

FIG. 2M is a magnified view of the device shown in FIG. 2L.

FIG. 2N is a schematic side sectional view of the orthodontic device of FIGS. 2A-2D in a locked support mode, taken along section A-A of FIG. 2D.

FIG. 20 is a magnified view of the device shown in FIG. 2N.

FIG. 3A is a front, top, right side perspective view of an orthodontic device, according to another embodiment.

FIG. 3B is a front, top, right side perspective view of the orthodontic device of FIG. 3A in an open mode.

FIG. 3C is a schematic side sectional view of the orthodontic device of FIG. 3B in the open mode.

FIG. 3D is a schematic side sectional view of the orthodontic device of FIG. 3A in a sliding mode.

FIG. 3E is a schematic side sectional view of the orthodontic device of FIGS. 3A-3B in a locked mode.

FIG. 4A is a front, top, right side perspective view of an orthodontic device, according to another embodiment.

FIG. 4B is a schematic side sectional view of the orthodontic device of FIG. 4A in an open mode.

FIG. 4C is a schematic side sectional view of the orthodontic device of FIG. 4A in a sliding mode.

FIG. 4D is a schematic side sectional view of the orthodontic device of FIG. 4A in a locked mode.

FIG. 5A is a front, top, right side perspective view of an orthodontic device, according to another embodiment.

FIG. 5B is a schematic side sectional view of the orthodontic device of FIG. 5A in an open mode.

FIG. 5C is a schematic side sectional view of the orthodontic device of FIG. 5A in a sliding mode.

FIG. 5D is a schematic side sectional view of the orthodontic device of FIG. 5A in a locked mode.

FIG. 6A is a front, top, right side perspective view of an orthodontic device, according to another embodiment.

FIG. 6B is a rear, top, left side perspective view of the orthodontic device of FIG. 6A.

FIG. 6C is a schematic front, top, right side perspective view of a wedge member of the device in FIGS. 6A-6B.

FIG. 6D is a schematic front, top, right side perspective view of a clip used in the device in FIGS. 6A-6B.

FIG. 6E is a schematic front, top, right side perspective view a bracket used in the device in FIGS. 6A-6B.

FIG. 6F is a schematic top plan view of the bracket in FIG. 6E.

FIG. 6G is a schematic top plan view of the orthodontic device in FIGS. 6A-6B in a sliding support mode.

FIG. 6H is a schematic top plan view of the orthodontic device in FIGS. 6A-6B in a locked support mode.

FIG. 7 is a schematic top plan view of an orthodontic device, according to another embodiment.

FIG. 8 is a side sectional view of an orthodontic device, according to another embodiment.

FIG. 9A is a back, right perspective view of an orthodontic device, according to another embodiment.

FIG. 9B is a front sectional view of the orthodontic device of FIG. 9A.

FIG. 10 is a schematic rear plan view of an orthodontic device, according to another embodiment.

FIG. 11 is a schematic top plan view of an orthodontic device, according to another embodiment.

Throughout the drawings, unless otherwise noted, reference numbers may be re-used to indicate a general correspondence between referenced elements. The drawings are provided to illustrate example embodiments described herein and are not intended to limit the scope of the disclosure.

### DETAILED DESCRIPTION

Conventional orthodontic devices are designed to straighten teeth using only one particular mode of operation. For example, some conventional devices utilize a sliding mode of operation, in which the orthodontic wire can slide laterally relative to the bracket. In traditional sliding-mode orthodontic devices, a ligature (e.g., elastic band or steel ligature) can be connected to hooks of the bracket over the wire to secure the wire to the bracket. In self-ligating sliding-mode devices, the wire can be inserted into the bracket and secured mechanically without using ligatures. In passive self-ligating devices, for example, the wire may be unconstrained in the bracket so as to slide laterally relatively freely. By contrast, in active self-ligating devices, a clip can express a force against the wire to contain the wire within a retention cavity of the bracket. In both active and passive self-ligating devices, the wire can slide laterally relative to the bracket, but active devices may induce larger frictional forces as compared with passive devices. Examples of such active and passive sliding mode devices may be found, for example, in U.S. Pat. Nos. 6,071,119 and 9,615,899.

Thus, traditional and self-ligating sliding devices like those mentioned above operate in only a single mode that enables a substantial amount of sliding between the wire and the bracket. However, conventional sliding devices may impart an unpredictable force on all of the teeth connected by the archwire, which can make tooth adjustments inefficient and/or unpredictable, and which may negatively affect patient outcomes. Frictional forces may induce binding of the wires, further reducing treatment predictability and treatment time. Wires may also slide excessively so as to contact buccal tissue and cause discomfort to the patient.

Other types of conventional orthodontic devices utilize a frictionless mode of operation. For example, clear alignment trays can be worn over the teeth and can be shaped to straighten a patient's teeth. These alignment trays tend to only be effective in correcting mild malocclusion and the outcomes are seldom persistent, even if a retainer is worn daily post-treatment. Over time, maintaining well aligned teeth can be costly and inconvenient for the patient. In other frictionless devices, wires can be applied to the tooth and bent in desired configurations to align a patient's teeth. These frictionless devices also have a single mode of operation in which a wire or tray is fixed relative to the teeth that are to be treated. Some frictionless devices are applied by bending wires into loops and bends during an appointment, which is inefficient for the clinician. Moreover, the use of wire loops can be uncomfortable and difficult to clean for the patient. Many of the bends in the wire are often replicated through the end of the treatment, which can be difficult and time-consuming.

Accordingly, there remains a continuing need for improved orthodontic devices. Various embodiments disclosed herein relate to orthodontic devices that have a plurality of operating or wire support modes, as opposed to only a single support or operating mode. The devices can include a bracket configured to support an orthodontic wire and a locking assembly that includes one or a plurality of locking component(s) connected to the bracket. The locking assembly can be switchable between a plurality of support modes. For example, the locking assembly can include a first sliding mode in which the orthodontic wire is laterally slidable relative to the bracket, and a second locked mode in which the orthodontic wire is slidably locked relative to the bracket.

Beneficially, and as explained herein, the disclosed orthodontic devices can provide increased treatment controllability, reduced treatment times, and improved patient health outcomes. Moreover, the use of orthodontic devices with multiple operational modes can enable patient-specific design of an orthodontic system to concurrently and efficiently treat multiple misaligned teeth.

### I. Overview of Device Components

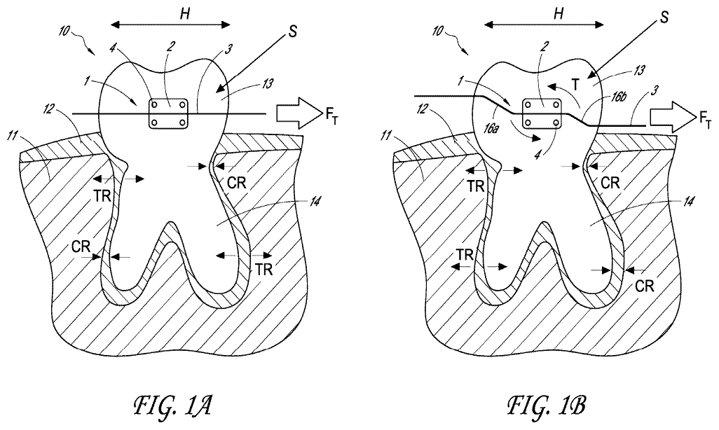

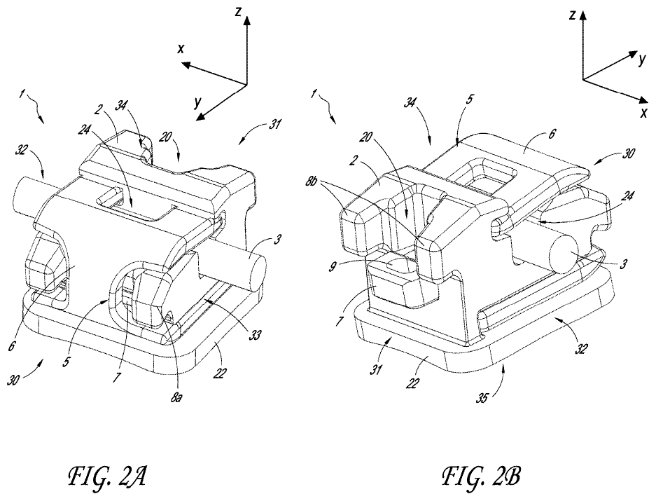

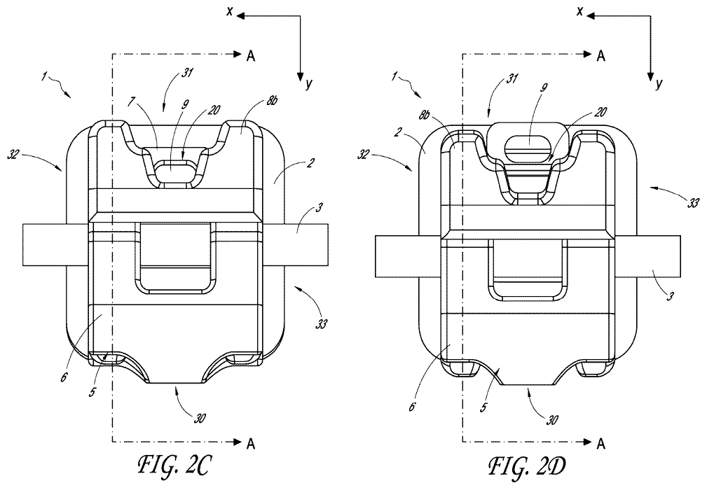

FIG. 1A is a schematic side view of a tooth 10 to be treated using an orthodontic treatment device 1, in which an orthodontic tension force F_{T} is applied to move the tooth 10 laterally in a horizontal direction H, e.g., distally or mesially. The tooth 10 can comprise a crown 13 and one or a plurality of roots 14 extending apically from the crown 13. The tooth 10 can be embedded in gum tissue 12. The gum tissue 12 can be disposed over bone structure 11 and between the bone structure 11 and the tooth 10. The tooth 10 shown in FIG. 1A is a molar tooth, but it should be appreciated that the tooth 10 can comprise any suitable type of tooth, such as a molar, a pre-molar, an anterior, an incisor, a bicuspid, a canine, etc. Moreover, the tooth 10 shown in FIG. 1A can be a mandibular tooth or a maxillary tooth. One tooth 10 is shown in FIG. 1A for illustrative purposes, but the devices described herein can be used on multiple teeth, including all the teeth of a patient, or a subset of all the teeth of a patient.

If the clinician determines that the tooth 10 is misaligned, the clinician can provide an orthodontic treatment device 1 to the tooth 10 to align or straighten the tooth 10 relative to adjacent teeth and/or the mandibular or maxillary bone structures. The orthodontic device 1 can comprise a bracket 2 affixed to an attachment surface S of the tooth 10. For example, the clinician can use an adhesive or cement to affix the bracket 2 to the attachment surface S of the tooth 10. The attachment surface S can comprise a labial or buccal surface of the tooth 10 in some embodiments. In other embodiments, the attachment surface S can comprise a lingual surface of the tooth 10. An orthodontic wire 3 (e.g., archwire) can be mechanically coupled to the bracket 2. For example, in some embodiments, the wire 3 can be inserted into a retention cavity of the bracket 2. The wire 3 can comprise any suitable type of orthodontic wire, such as a metallic wire. For example, the wire 3 can comprise stainless steel, a nickel titanium alloy, a copper titanium alloy, or any other suitable material. In some embodiments, the wire 3 can comprise a pre-programmed wire that is shaped to have a desired curvature or shape based on the patient's malocclusion characteristics. In some embodiments, the wire 3 can comprise a straight wire. The wire 3 can comprise a shape memory alloy in various embodiments.

In some arrangements, the device 1 can include one or a plurality of hooks 4 onto which an elastic ligature or band (not shown) is looped. In such devices, the ligature can prevent the wire 3 from separating or coming out of the bracket 2. Additionally or alternatively, a clip or other structure can prevent the wire 3 from coming out of the bracket 2. In conventional orthodontic devices, stress and strain can be generated with the bracket and wire to impart movement of the tooth 10. In orthodontic devices, frictional resistance can be determined based on the design of the bracket 2, such as the space for receiving the archwire 3, the angle of the archwire 3 relative to the bracket 2, the torque at the bracket-archwire interface, and the type of ligation. Frictional resistance may additionally or alternatively be determined based on the design of the archwire 3, including the wire's size and stiffness, the shape (round or polygonal), and the surface friction which may depend on the materials, surface treatments like ionization, and coatings of the archwire 3.

As an example, FIG. 1A illustrates the application of only a tension force F_{T} to a tooth to be treated. The tension force F_{T} can be applied to the tooth 10 by way of the device 1 in a variety of ways. In various disclosed embodiments, the bracket 2 can have a locking mode in which the wire 3 is locked relative to the bracket 2 so as to prevent sliding between the wire 3 and the bracket 2 when subjected to typical orthodontic forces. In such an embodiment, the wire 3 can be pre-programmed or otherwise configured to induce a horizontal tension force F_{T} disposed along a horizontal direction H on the wire 3 and bracket 2. As shown, the horizontal direction H can correspond to a mesial or distal direction relative to the tooth 10. In other embodiments, for example, in which the bracket 2 is in a sliding mode, the tension force F_{T} can be applied to the bracket 2 by suitably selecting or altering the wire 3 and/or connecting the wire 3 to other teeth in the mouth.

The tension force F_{T} can be selected so as to induce the desired movement of the tooth 10 relative to the bone structure 11. In the illustrated embodiment, the applied tension force F_{T} can impart respective tensile regions TR and compressive regions CR between the tooth 10 and the neighboring gum tissue 12 and bone structure 11. Over time, the tooth 10 can move such that bone resorption occurs at compressive regions CR and bone formation occurs at tensile regions TR.

FIG. 1B is a schematic side view of a tooth 10 to be treated using an orthodontic treatment device 1, in which a tension force F_{T} is applied to impart a torque load T to rotate the tooth 10. Unless otherwise noted, the components of FIG. 1B may be the same as or generally similar to like-numbered components of FIG. 1A. As with FIG. 1A, a tension force F_{T} is applied to the tooth 10 by way of the bracket 2. However, in FIG. 1B, a plurality of bends 16a, 16b are formed in the wire 3 so that the applied tension force F_{T} imparts a counterclockwise torque T to the bracket 2 and tooth 10. The induced torque T can be adjusted by bending the wires 3 at a desired angle such that the tension force F_{T} imparts a desired moment or torque. Many combinations of applied forces can be used for a patient's treatment plan based on the characteristics of the patient's malocclusion. Converting the tensile force F_{T} to a torque T or moment can create different force profiles in the gum and bond structure. As shown in FIG. 1B, for example, the induced tensile and compressive regions TR, CR, may differ relative to those of FIG. 1A, which accordingly can create different movement of the tooth 10 as compared to FIG. 1A.

### II. Examples of Orthodontic Devices

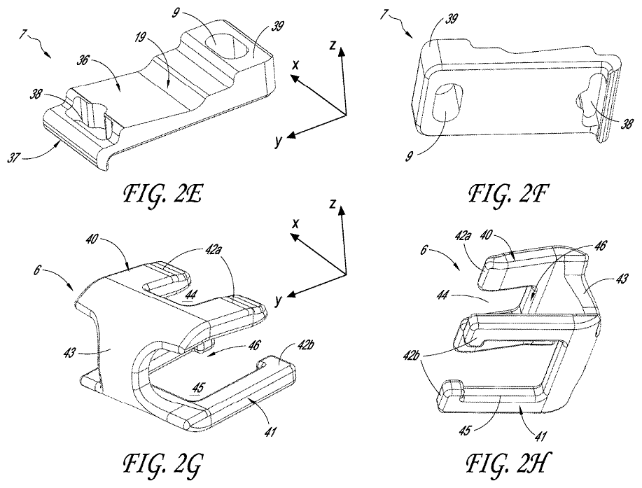

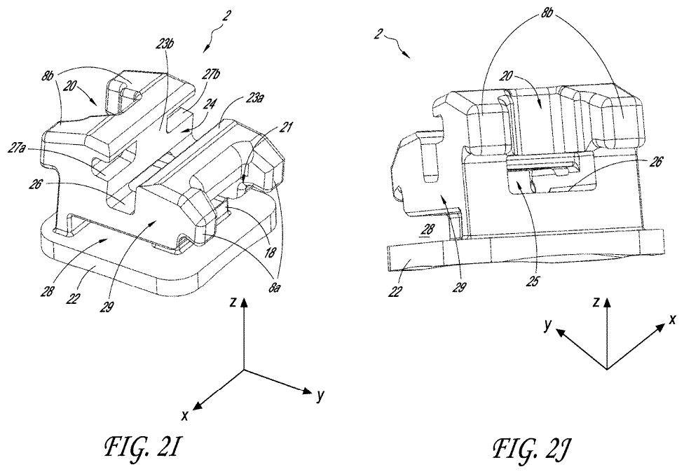

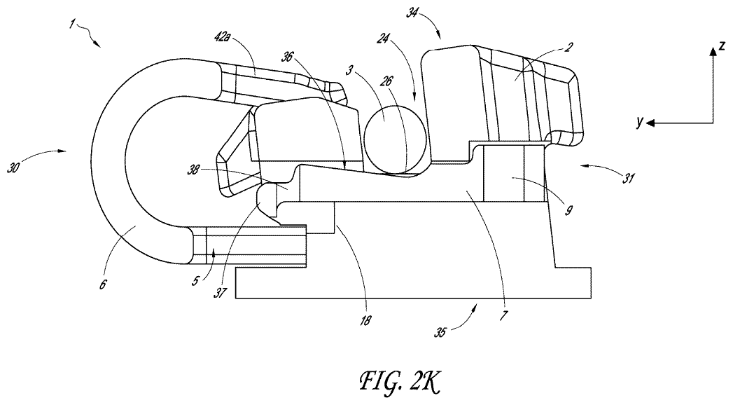

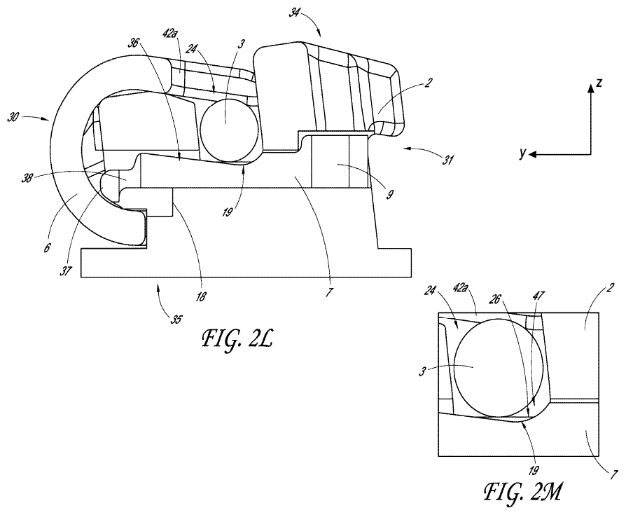

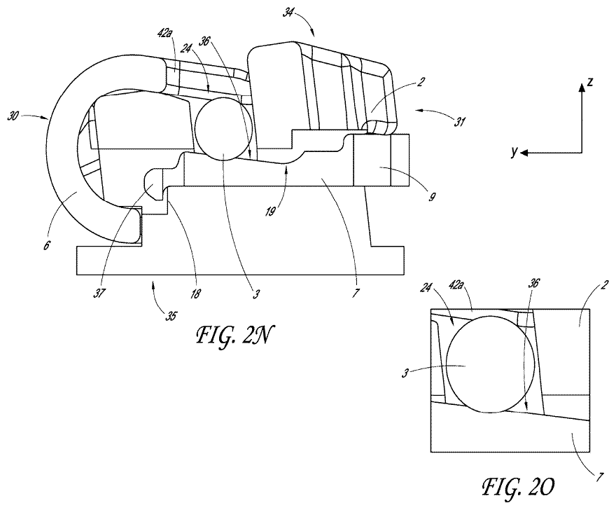

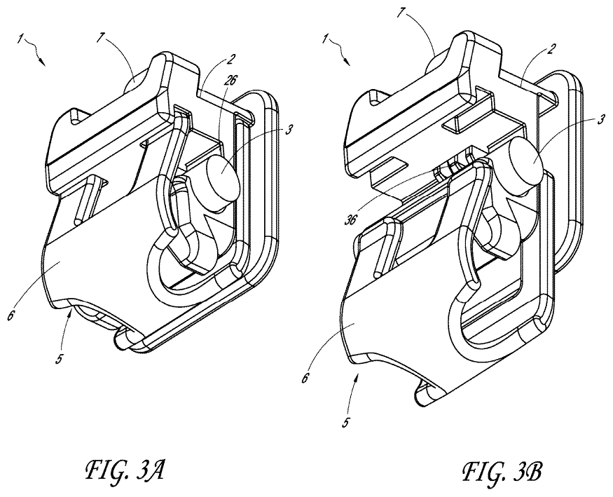

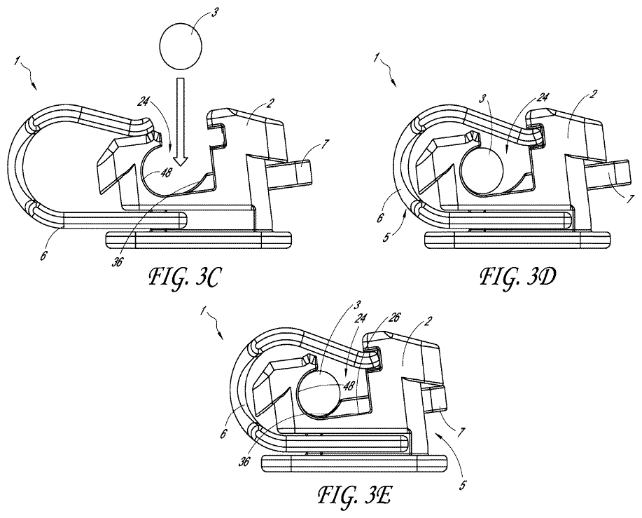

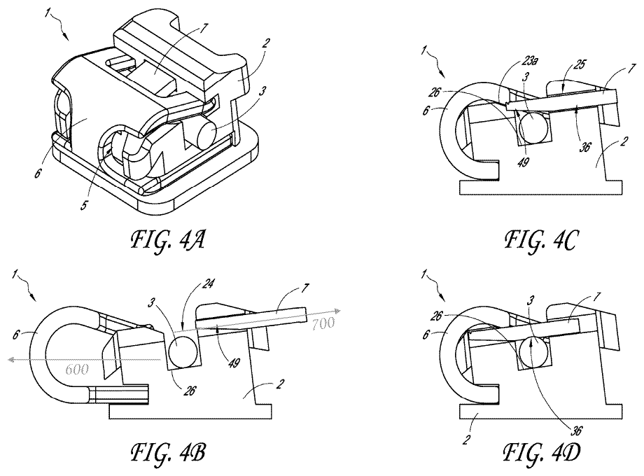

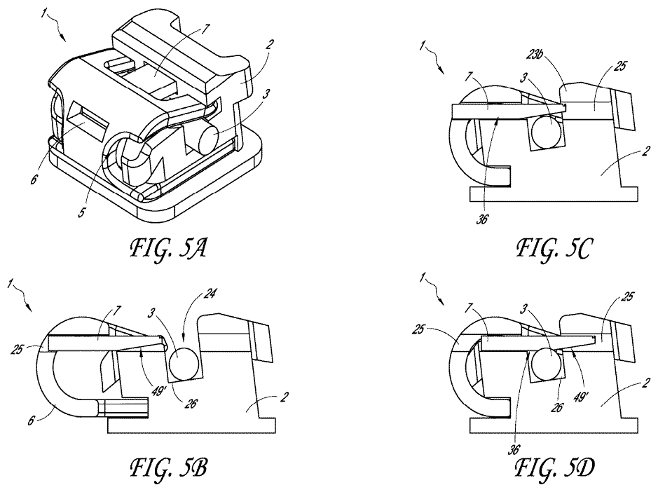

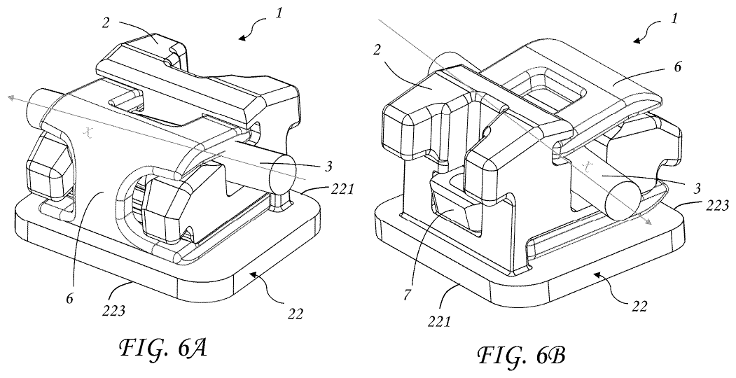

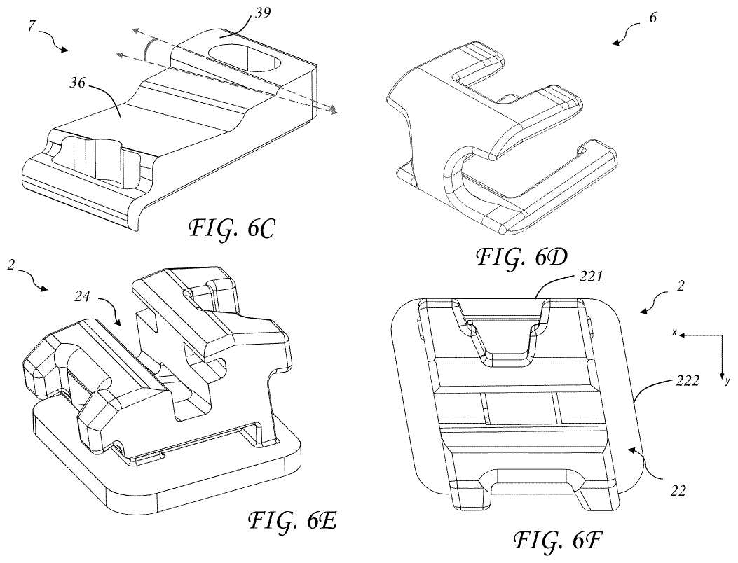

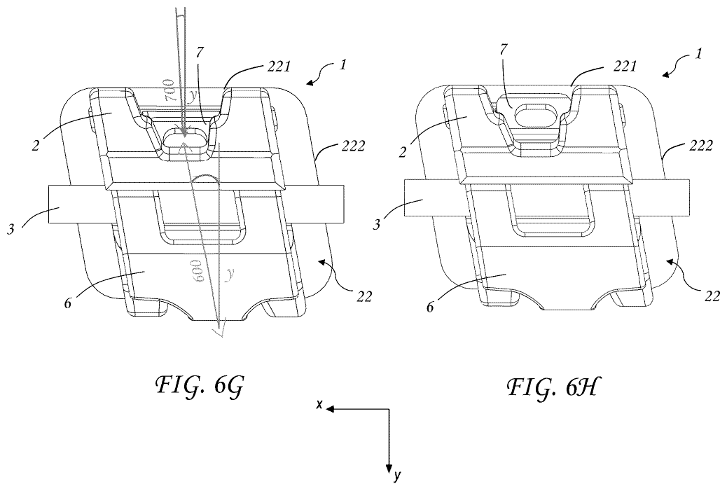

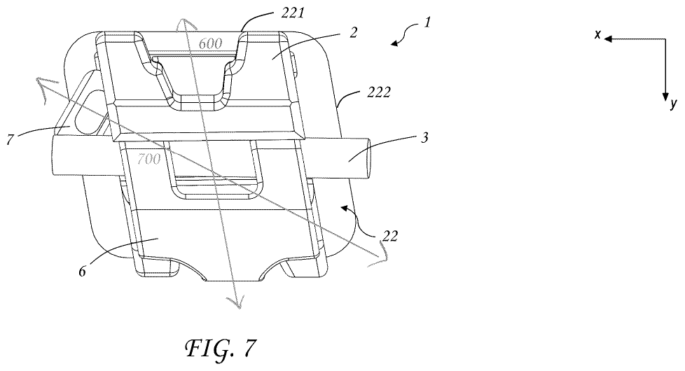

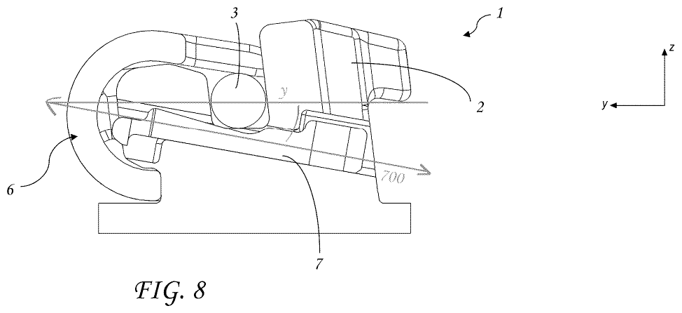

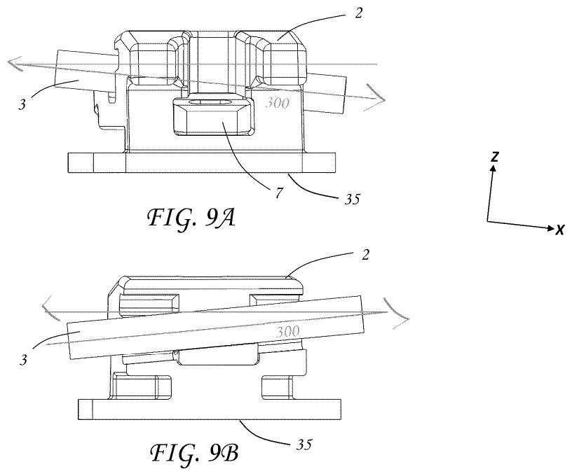

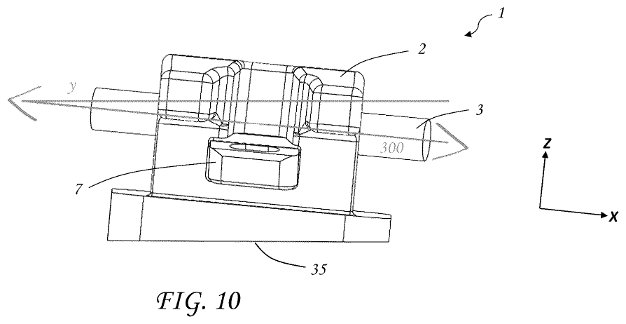

FIGS. 2A-11 illustrate examples of orthodontic devices 1, in accordance with various embodiments disclosed herein. The orthodontic devices 1 of FIGS. 2A-11 can include a bracket 2 configured to support an orthodontic wire 3 and a locking assembly 5 connected to the bracket 2. In each of the embodiments disclosed herein, the locking assembly 5 can be pre-assembled or connected to the bracket 2 by the manufacturer before being used by the clinician, in some embodiments. In other embodiments, the locking assembly 5 and bracket 2 can be provided separately in a kit to the clinician, and the clinician or staff can assembly or connect (e.g., couple) the locking assembly 5 to the bracket 2. The locking assembly 5 can be switchable between a plurality of operational modes. For example, the locking assembly 5 can include a first sliding mode in which the orthodontic wire 3 is laterally slidable relative to the bracket 2, and a second locked mode in which the orthodontic wire 3 is slidably locked relative to the bracket 2. The device 1 can also include a third open mode in which the wire 3 can be inserted into the bracket 2. In the first sliding mode, the locking assembly 5 can serve in passive or active ligation modes. In a passive ligation sliding mode, the locking assembly 5 may not contact (or may only minimally or incidentally contact) the wire 3, such that the wire 3 can laterally slide relative to the bracket 2 when the bracket 2 or the wire 3 are subjected to typical orthodontic forces. In an active ligation sliding mode, the locking assembly 5 may contact the wire 3 but may impart a frictional force to the wire 3 by way of an applied normal force. In the active sliding mode, the frictional force may be less than typical orthodontic forces imparted to the bracket 2 or the wire 3.

By contrast, in the second locked mode, the locking assembly 5 can be configured to apply locking forces (e.g., a normal force) against the wire 3 to prevent the wire 3 from laterally sliding relative to the bracket 2 when typical orthodontic forces are imparted to the bracket 2 or the wire 3. The use of multiple support modes can advantageously provide the clinician with more flexibility during treatment, which can improve patient outcomes and reduce treatment times. It should be appreciated herein that the locking and sliding modes can be selected independently by the clinician for a set of teeth. For example, the clinician can place one or more teeth in the first sliding mode, and one or more other teeth in the second locked mode. Over the course of treatment, the clinician can switch one or more teeth from the locked mode to the sliding mode, or from the sliding mode to the locked mode. In some procedures, one or more teeth may remain in the locked mode throughout the course of treatment. One or more teeth may remain in the sliding mode throughout the course of treatment. Beneficially, the clinician can independently select whether a tooth to be treated is to be placed in the locked mode or the sliding mode, and/or whether to switch modes during the course of treatment.

Thus, in various embodiments, the locking assembly 5 can serve as a fixation mechanism or braking assembly to apply a frictional force against a wire 3 during use in a patient. The frictional forces can comprise clamping or braking forces applied to the wire 3 to resist sliding movement of the wire 3 as explained herein. The locking assembly 5 can serve as a friction adjustment mechanism to adjust a frictional force against the orthodontic wire. The frictional adjustment mechanism can be adjustable to exert a range of sliding and non-sliding frictional forces against the orthodontic wire 3 in use. The locking assembly 5 can adjust the frictional force in a continuous manner or in a step-wise manner. In various embodiments, the applied frictional forces can permit sliding, or prevent sliding when the wire is subject to typical orthodontic forces.

### A. Orthodontic Devices Having Locking Assemblies With Wedge Members

In various embodiments, the locking assembly 5 can include a wedge member 7 that engages with the bracket 2 to secure the wire 3 to the bracket 2 in a plurality of operational or support modes. FIGS. 2A-2O illustrate one embodiment of an orthodontic device 1 that includes a bracket 2 and a locking assembly 5 mechanically connected to the bracket 2. The locking assembly 5 can include a clip 6 and wedge member 7 that cooperate with one another and with the bracket 2 to provide an open mode, a sliding support mode, and a locked support mode. Although the locking assembly 5 includes the clip 6 in the illustrated embodiments, in some embodiments, there may be no clip. In such embodiments, ligaments or elastic bands can be used to retain the wire 3 in the bracket 2.

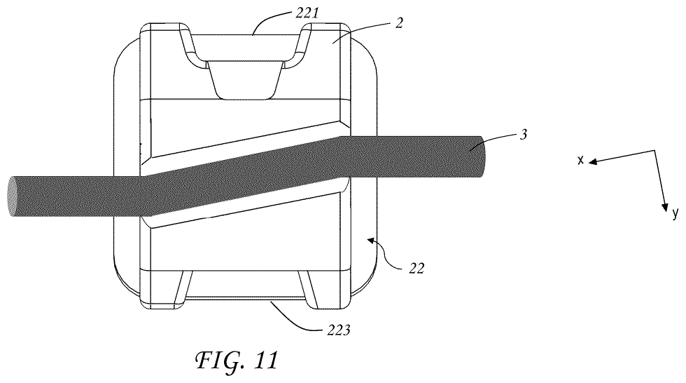

FIG. 2A is a schematic front, top, right side perspective view of the orthodontic device 1. FIG. 2B is a schematic rear, top, left perspective view of the device 1 of FIG. 2A. FIG. 2C is a schematic top plan view of the device 1 of FIGS. 2A-2B in a sliding support mode. FIG. 2D is a schematic top plan view of the device 1 of FIGS. 2A-2B in a locked support mode. FIG. 2E is a schematic front, top, right side perspective view of the wedge member 7 of FIGS. 2A-2D. FIG. 2F is a schematic rear, bottom, left side perspective view of the wedge member 7 of FIG. 2E. FIG. 2G is a schematic front, top, right side perspective view of the clip 6 of FIGS. 2A-2D. FIG. 2H is a schematic rear, bottom, left side perspective view of the clip 6 of FIG. 2G. FIG. 2I is a schematic front, top, left side perspective view of the bracket 2 of FIGS. 2A-2D. FIG. 2J is a schematic rear, right side perspective view of the bracket 2 of FIG. 2I. FIG. 2K is a schematic side sectional view of the orthodontic device 1 of FIGS. 2A-2D in the open support mode, taken along section A-A of FIGS. 2C-2D. FIG. 2L is a schematic side sectional view of the orthodontic device 1 of FIGS. 2A-2D in the sliding support mode, taken along section A-A of FIG. 2C. FIG. 2M is a magnified view of the device 1 shown in FIG. 2L. FIG. 2N is a schematic side sectional view of the orthodontic device 1 of FIGS. 2A-2D in the locked support mode, taken along section A-A of FIG. 2D. FIG. 20 is a magnified view of the device 1 shown in FIG. 2N.

As shown in FIGS. 2A-2D and 2K-2O, an orthodontic wire 3 can be inserted into a retention cavity 24 of the bracket 2. As explained above, the orthodontic wire 3 can comprise an archwire that provides a desired profile for the patient's maxillary or mandibular teeth to improve alignment of the patient's teeth. In various embodiments, the wire 3 can comprise a metal, such as stainless steel, a nickel titanium alloy, a copper titanium alloy, or any other suitable material. For example, in some embodiments, the wire 3 can comprise a shape memory alloy. In some embodiments, the wire 3 can comprise a pre-programmed wire that is shaped to have a desired curvature or shape based on the patient's malocclusion characteristics. In some embodiments, the wire 3 can comprise a straight wire. The wire 3 can be shaped to include loops, kinks, bends, twists, inflections, or other shapes to apply suitable forces and/or torques to one or more teeth under treatment. Additionally or alternatively, the wire 3 can be pre-tensioned, pre-compressed, pre-bent, or otherwise biased in a desired mechanical configuration so as to provide adequate treatment for a patient's malocclusion. Any suitable elastic bands, springs, spacers, or other supplemental treatment devices can be used in conjunction with the devices 1 shown herein. Further, although one wire 3 is shown in the retention cavity 24 of the bracket 2 in FIGS. 2A-2O (and in other embodiments), it should be appreciated that more than one (e.g., two, three, etc.) may be provided in the retention cavity 24 in various arrangements (see, e.g., FIGS. 30-31). The wire 3 shown in FIGS. 2A-2O (and in other embodiments) is a rounded (e.g., elliptical or circular cross-section) wire, but in various arrangements, the wire 3 can comprise a polygonal (e.g., rectangular or square) wire.

The wire 3 can extend along a local lateral axis x of the device 1 as shown in FIGS. 2A-2D. The device 1 can have a left side 32 and a right side 33 opposite the left side 32 along the lateral axis x. In the sliding mode of the device 1, the wire 3 can slide laterally relative to the bracket 2 along the lateral axis x. In the locked or non-sliding mode of the device 1, the wire 3 is locked such that the wire 3 is prevented from sliding laterally relative to the bracket along the lateral axis x. In some embodiments, the locked mode of the device 1 locks six degrees-of-freedom (6-DOF) of the wire 3 relative to the bracket 2. In other embodiments, the locked mode locks less than 6-DOF. For example, as explained herein, the locked mode can lock the wire 3 in at least 1-DOF, such as a laterally sliding mode to prevent the wire 3 from sliding along the x axis. Additionally or alternatively, the locked mode can lock the wire 3 rotationally to prevent the wire 3 from rotating about its own axis (e.g., the lateral x-axis). In other embodiments, the locked mode can permit the wire 3 to rotate about the x-axis. Additionally or alternatively, the locked mode can also lock the wire 3 to prevent the wire 3 from translating vertically along the z-axis. Additionally or alternatively, the locked mode can also lock the wire 3 to prevent the wire 3 from translating transversely along the y-axis. Additionally or alternatively, the locked mode can lock the wire 3 to permit the wire 3 from locally rotating about the y- or z-axes at or near locations at which the locking assembly 5 contacts the wire 3.

As illustrated in FIGS. 2A-2D and 2K-2O, the clip 6 and wedge member 7 can be mechanically engaged with the bracket 2 crosswise or transverse (e.g., non-parallel to) the wire 3 and the lateral axis x along a local transverse axis y of the device 1. The device 1 can have a front side 30 and a rear side 31 opposite the front side 30 along the transverse axis y. The clip 6 and the wedge member 7 can be moved (e.g., translated) along the transverse axis y to switch between the open mode, the sliding mode, and the fixed mode. In the illustrated embodiment, the clip 6 and wedge member 7 can be moved transversely in a generally perpendicular direction relative to the lateral axis x such that the transverse axis y is generally perpendicular to the lateral axis x. In other embodiments, the transverse movement of the clip 6 and/or wedge member 7 may not be perpendicular relative to the lateral axis x, but may still be non-parallel or transverse relative to the wire 3 and lateral axis x. When the bracket 2 is attached to the tooth 10, the clip 6 and/or wedge member 7 can translate in the gingival-occlusal plane of the tooth 10.

The device 1 and its respective components can also include a top side 34 and a bottom side 35 opposite the top side 34 along a local vertical axis z of the device 1. During an orthodontic treatment procedure, a base 22 of the bracket 2 at the bottom side 35 of the device 1 can be affixed to the tooth 10 using, e.g., a cement or other adhesive. As explained above, the bracket 2 can be positioned on a buccal or labial surface, or on a lingual surface in various embodiments. In some embodiments, the device 1 can be affixed to the tooth 10 such that the front side 30 faces in a gingival direction (e.g., generally toward the gum tissue 12), and such that the rear side 31 faces in an occlusal or incisal direction (e.g., generally towards occlusal or incisal surfaces of the tooth 10). In other embodiments, the device 1 can be affixed to the tooth 10 such that the front side 30 faces in an occlusal or incisal direction, and such that the rear side 31 faces in a gingival direction.

Turning to FIGS. 2E-2F, the wedge member 7 can include a tapered wedge surface 36 angled vertically relative to the vertical axis z. As explained above, the wedge member 7 can serve as a locking member to lock the wire 3 relative to the bracket 2. In FIGS. 2E-2F, the wedge member 7 can be thicker at its front and rear ends than at a depressed surface 19 between the front and rear ends. The tapered wedge surface 36 can extend rearwardly from a second tooling aperture. In the illustrated embodiment, the wedge surface 36 is tapered downwardly and rearwardly, but in other embodiments, the wedge surface can be tapered downwardly and forwardly. The depressed surface 19 may be disposed rearward of the wedge surface 36. The portion of the wedge member 7 at the depressed surface 19 can be thinner than the portion of the wedge member 7 at the wedge surface 36. The wedge member 7 can include a raised rear portion 39 having a first tooling aperture 9 extending vertically therethrough along the vertical axis z. The clinician can use a suitable tool to engage with the first tooling aperture 9 (for example by inserting the tool into the aperture 9) to switch the device 1 from one support mode to another. The wedge member 7 can include a front stop portion 37 and the second tooling aperture 38 near the front stop portion 37. As explained herein, the front stop portion 37 can engage with a corresponding shoulder 18 of the bracket 2 (see FIG. 2I). The clinician can use a suitable tool to engage with the second tooling aperture 38 (for example by inserting the tool into the aperture 38) to switch the device 1 from one support mode to another. The wedge member 7 can comprise any suitable type of material, such as a metal, a plastic, etc. The wedge member 7 can be sufficiently stiff so as to impart significant forces against the wire 3 when the device 1 is in the locked mode.

As shown in FIGS. 2F and 2G, the clip 6 can include an upper portion 40 and a lower portion 41 spaced apart from the upper portion 40 along the vertical axis z. A vertically extending connection portion 43 can connect the upper and lower portions 41, 42. The upper portion 40 can include a pair of upper arms 42a laterally spaced apart along the lateral axis x by an upper gap 44. The lower portion 41 can include a pair of lower arms 42b laterally spaced apart along the lateral axis x by a lower gap 45. The clip 6 can include a clip cavity 46 disposed between the upper and lower portions 40, 41. The clip 6 can comprise any suitable type of material, such as a metal. The clip 6 can be sufficiently stiff so as to impart significant forces against the wire 3 when the device 1 is in the locked mode.

As shown in FIGS. 21-2J, the bracket 2 can include a support portion 29 extending from the base 22. The support portion 29 can be sized and shaped to receive and support the wire 3, the wedge member 7, and the clip 6. As shown in FIGS. 21-2J, a lower recess 28 can be formed in the bracket 22 to vertically separate portions of the support portion 29 from the base 22. The lower recess 28 can be angled or curved so as to be partially revolved around the vertical axis z to form a gap between the support portion 29 and the base 22. The shoulder 18 can define an inner surface of the lower recess 28. The retention cavity 24 can be defined in the support portion 29 at least in part by a front wall 23a, a rear wall 23b spaced apart from the front wall 23a along the transverse axis y, and a retention surface 26 disposed transversely relative to the front and rear walls 23a, 23b. The retention cavity 24 can extend completely through the support portion 29 along the lateral axis x in the illustrated embodiment.

The support portion 29 can include one or more front hooks 8a and one or more rear hooks 8b. The front hooks 8a can be disposed at the front side 30 of the device 1. The rear hooks 8b can be disposed at the rear side 31 of the device 1. In FIGS. 2A-2D and 21-2J, a pair of front hooks 8a can be spaced apart by a front spacing 21, and a pair of rear hooks 8b can be spaced apart by a rear spacing 20. In some embodiments, ligatures (e.g., clastic bands or steel ligatures) can be stretched around the hooks 8a-8b to retain the wire 3 in the retention cavity 24. In other embodiments, no ligatures may be used, and the clip 6 may serve to retain the wire 3 in the retention cavity 24.

The support portion 29 can also include upper recesses 27a, 27b. The upper recesses 27a, 27b can be laterally spaced apart from one another by the rear wall 23b along the lateral direction x. The upper recesses 27a, 27b can extend rearward into the support portion 29 relative to the rear wall 23b along the transverse axis y. A transverse cavity 25 can extend transversely through the support portion 29 along the transverse axis y. The transverse cavity 25 can extend transversely (e.g., non-parallel) relative to the retention cavity 24. In the illustrated embodiment, the retention surface 26 may also serve as a floor or bottom surface of the transverse cavity 25. As shown in FIGS. 21-2J, the transverse cavity 25 can be positioned vertically along the z-axis between the lower recess 28 and the upper recesses 27a, 27b. In the illustrated embodiment, the transverse cavity 25 extends completely through the support portion 29 along the transverse axis y. In other embodiments, the transverse cavity 25 may extend only partially through the support portion 29 along the transverse axis y.

When assembled, as shown in FIGS. 2A-2D, the wedge member 7 can extend transversely through the transverse recess 25 of the bracket 2, with the rear raised portion 39 disposed at the rear side 31 of the device 1. The upper arms 42a of the clip 6 can be inserted into the upper recesses 27a, 27b of the bracket 2. The lower arms 42b of the clip 6 can be inserted into the lower recess 28 of the bracket 2. The vertically extending connection portion 43 of the clip 6 can be positioned in or near the front spacing 21 of the bracket 2. Thus, in FIGS. 2A-2D, the wire 3, the wedge member 7, the front wall 23a, and the retention surface 26 of the bracket 2 can be disposed in the clip cavity 46 vertically between the upper and lower portions 40, 41 of the clip 6. In the illustrated embodiment, moreover, the wedge member 7 can be positioned vertically between the wire 3 and the retention surface 26 of the bracket 2. In other embodiments, however, the wire 3 can be positioned vertically between the wedge member 7 and the retention surface 26.

Turning to the operation of the device 1, the clinician can load or insert the wire 3 by placing the device 1 in the open mode, as shown in FIG. 2K. The wire 3 can be placed in the retention cavity 24 and onto the retention surface 26 of the bracket 2. In the open mode of FIG. 2K, the clip 6 is translated to a forward or front position along the transverse axis y such that the upper arms 42a expose the retention cavity 24. The wedge member 7 is also translated to, or kept in, a forward or front position along the transverse axis y such that the clinician can access the second tooling aperture 38 and such that the front stop portion 37 is positioned forward of the shoulder 18. In the open mode, the wire 3 may be supported only by the retention cavity 24, e.g., by the retention surface 26 and the front and rear walls 23a, 23b of the bracket 2. In some embodiments, ligaments can be stretched over the hooks 8a, 8b to retain the wire 3 in the cavity 24, and the clip may be omitted.

Turning to FIGS. 2L and 2M, the device 1 is illustrated in a sliding mode. The clinician can move the device 1 from the open mode to the sliding mode by translating the clip 6 rearwardly along the transverse axis y into a rear position such that the upper arms 42a are disposed over the wire 3 in the retention cavity 24 and into the upper recesses 27a, 27b, and such that the lower arms 42b are disposed in the lower recess 28. In the sliding mode, the upper arms 42a of the clip can retain the wire 3 in the retention cavity 24, e.g., to prevent the wire 3 from moving vertically along the z-axis out of the cavity 24. The wedge member 7 may be kept in, or switched to, the forward position such that the wedge surface 36 does not impart forces on the wire 3. For example, as shown in FIG. 2M, a space 47 may be provided between the wire 3 and the depressed surface 19 of the wedge member 7 such that the wedge surface 36 does not impart forces on the wire 3. In the sliding mode, the upper arms 42a may or may not contact the wire 3, such that the upper arms 42a provide active or passive ligation support. In the sliding mode of FIGS. 2L and 2M, the wire 3 can laterally slide along the lateral axis x. In an active sliding mode, frictional forces may be applied to the wire 3 at magnitudes less than typical orthodontic forces to provide sliding resistance but not at magnitudes sufficient to prevent or lock sliding. In a passive sliding mode, the wire can slide relatively freely relative to the bracket 2.

If the clinician wishes to place the device 1 in the locked or non-sliding mode, a tool can be used to engage the second tooling aperture 38 to translate the wedge member 7 rearwardly along the transverse axis y to a rear position, as shown in FIGS. 2N and 2O. The clip 6 can be kept in, or translated to, the rear position shown in FIG. 2L. If the clinician wishes to switch the device 1 to the sliding mode from the locked mode, the clinician can engage the first tooling aperture 9 to translate the wedge member 7 to the forward position. The clinician can further switch the device 1 to the open mode by keeping the wedge member 7 in the forward position and translating the clip 6 to the forward position.

In the locked or non-sliding mode of FIGS. 2N and 2O, the wedge member 7 can accordingly be moved sufficiently rearwardly such that the tapered wedge surface 36 contacts and expresses a locking force against the wire 3. In some embodiments, the tapered wedge surface 36 may have a curvature complementary to the curvature of the wire 3. The front stop portion 37 can engage the shoulder 18 to prevent the wedge member 7 from being removed entirely from the transverse recess 25. As shown in FIGS. 2N and 2O, the tapered wedge surface 36 of the wedge member 7 and the upper arms 42a of the clip 6 can mechanically cooperate to clamp the wire 3 therebetween. The wedge surface 36 can be shaped such that when the wedge member 7 is in the rear position, the wedge surface 36 and clip 6 exert a sufficiently strong force against the wire such that typical orthodontic forces do not impart sliding translation to the wire 3 relative to the bracket 2.

In various embodiments, for example, the locking assembly 5 (e.g., the wedge member 7 and the clip 6) in the locking or non-sliding mode can exert a frictional force against the wire 3 that is at least 50 cN, at least 75 cN, at least 100 cN, at least 150 cN, at least 200 cN, at least 250 cN, at least 300 cN, at least 350 cN, at least 500 cN, or at least 1000 cN. The locking assembly 5 can exert a frictional force against the wire that is in a range of 50 cN to 800 cN, in a range of 50 cN to 200 cN, in a range of 50 cN to 100 cN, in a range of 50 cN to 2000 cN, in a range of 50 cN to 1000 cN, in a range of 75 cN to 2000 cN, in a range of 75 cN to 1000 cN, in a range of 100 cN to 750 cN, in a range of 100 cN to 700 cN, in a range of 100 cN to 600 cN, in a range of 300 cN to 2000 cN, in a range of 350 cN to 2000 cN, or in a range of 500 cN to 2000 cN. In various embodiments, in the locking mode, the locking or frictional forces may be sufficiently high so as to indent or otherwise locally deform the wire.

In the sliding mode, the locking assembly 5 can exert a frictional force against the wire 3 that is less than the frictional force exerted in the locked mode. For example, in various embodiments, in the sliding mode, the locking assembly 5 can exert a frictional force of less than 50 cN, or less than 100 cN against the wire. In various embodiments, in the sliding mode, the locking assembly 5 can exert a frictional force against the wire in a range of 0 cN to 100 cN, in a range of 0 cN to 75 cN, or in a range of 0 cN to 50 cN. In various embodiments, the locking assembly 5 in the sliding mode can impart a frictional force against the wire 3 that is less than 90% of the frictional force imparted against the wire 3 in the locked mode, less than 80% of the frictional force imparted against the wire 3 in the locked mode, less than 70% of the frictional force imparted against the wire 3 in the locked mode, less than 60% of the frictional force imparted against the wire 3 in the locked mode, or less than 50% of the frictional force imparted against the wire 3 in the locked mode, In some embodiments, the frictional force imparted against the wire 3 in the sliding mode is in a range of 0% to 80% of the frictional force imparted against the wire in the locked mode, in a range of 0% to 50% of the frictional force imparted against the wire in the locked mode, or in a range of 25% to 80% of the frictional force imparted against the wire in the locked mode.

Accordingly, in various embodiments, the locking assembly 5 can be movable from a first configuration that allows sliding of the orthodontic wire 3 relative to the bracket 2 (e.g., a first sliding mode) to a second configuration that prevents sliding of the orthodontic wire 3 relative to the bracket 2 when the orthodontic wire 3 is subject to typical orthodontic forces during use of the orthodontic device (e.g., a second locked mode). In the second configuration (or the second locked mode), the wire 3 can be locked or non-sliding so as to substantially prevent sliding of the wire 3 relative to the bracket 2. For example, the second configuration or locked (e.g., non-sliding) mode can permit less sliding of the wire 3 than the amount of sliding permitted by typical active self-ligating orthodontic devices. Thus, the locked mode or configuration may permit a very small amount of sliding (e.g., less than 1 mm, less than 0.5 mm, or less than 0.1 mm) that is less than the amount of sliding permitted by conventional active orthodontic devices. Further, it should be appreciated that the sliding and locked modes described herein may be operated along a continuum such that the locking assembly 5 can be placed in multiple positions to enable sliding and/or locking. In some embodiments, therefore, the clinician can adjust the locking assembly 5 along a continuum of positions to express a range of frictional forces against the wire 3 in the sliding mode. Similarly, in some embodiments, multiple positions of the locking assembly 5 can serve to lock the wire 3 in the locked mode. Accordingly, the locking assembly 5 can be configured to apply a continuously variable frictional force to the wire 3. The continuously variable frictional force can be applied to move the wire 3 between the sliding and locked (e.g., non-sliding) configurations. The locking assembly 5 can apply continuously variable frictional forces within the sliding and/or locked modes. In other embodiments, however, the sliding and locked modes can comprise a discrete number of modes, as opposed to a continuum of modes. For example, the locking assembly 5 can be configured to adjust a frictional force to the wire 3 in a step-wise manner. The locking assembly 5 can be configured to move between the sliding and locked configurations in a step-wise manner.

It should be appreciated that, although the transverse recess 25 extends from the rear side 31 of the device 1 through the bracket 2 with the wedge member 7 disposed in the transverse recess 25 in the illustrated embodiment, in other embodiments, the wedge member can extend through an aperture at the front side 30 of the device 1, e.g., through an aperture in the clip 6. Further, although the wedge member 7 is shown as being disposed between the wire 3 and the retention surface 26, in other embodiments, the wedge member 7 can be disposed between the wire 3 and the clip 6 so as to press the wire 3 against the retention surface 26.

FIGS. 3A-3E illustrate an orthodontic device 1 that includes a bracket 2 and a locking assembly 5 mechanically connected to the bracket 2, according to another embodiment. Unless otherwise noted, the components of FIGS. 3A-3E may be the same as or generally similar to like-numbered components of FIGS. 1A-2O, and may function or operate in a generally similar manner. For example, as with FIGS. 2A-2O, the locking assembly 5 can include a clip 6 and wedge member 7 that cooperate with one another and with the bracket 2 to provide an open mode, a sliding support mode, and a locked support mode. In particular, FIG. 3A is a front, top, right side perspective view of the orthodontic device 1 in a sliding mode. FIG. 3B is a front, top, right side perspective view of the orthodontic device 1 of FIG. 3A in an open mode. FIG. 3C is a schematic side sectional view of the orthodontic device 1 of FIG. 3B in the open mode. FIG. 3D is a schematic side sectional view of the orthodontic device 1 of FIG. 3A in the sliding mode. FIG. 3E is a schematic side sectional view of the orthodontic device 1 of FIGS. 3A-3B in a locked mode.

The device 1 and its components can be combined with any suitable features of the embodiment of FIGS. 2A-2O, and may be positioned on any suitable surface of the tooth 10 to be treated (for example, a lingual surface, or a buccal or labial surface). The device 1 may also be oriented relative to the tooth 10 in any suitable manner (for example, with the front side facing gingivally or occlusally). Unlike the embodiment of FIGS. 2A-2O, however, the wedge member 7 can cooperate with a clamping surface 48 exposed to the retention cavity 24 of the bracket 2 to lock the wire 3 in the locked mode. Further, unlike the embodiment of FIGS. 2A-2O, the tapered wedge surface 36 can be disposed at a front end of the wedge member 7. As shown, for example, the wedge surface 36 can be angled downwardly and forwardly, rather than downwardly and rearwardly. The wedge surface 36 can accordingly comprise a ramped or tapered surface that can press against the wire 3 when in the locked mode.

As shown in FIG. 3C, in the open mode, the clip 6 can be moved or kept in a forward or front position to expose the retention cavity 24. The wedge member 7 can be moved or kept in a rear position. The wire 3 can be inserted into the retention cavity 24. In FIG. 3D, the clip 6 can be moved to a rear position to place the device 1 in a sliding mode. As shown, the wedge member 7 may remain in the rear position. Turning to FIG. 3E, the device 1 can be moved to the locked mode by translating the wedge member 7 forward to a front position such that the tapered wedge surface 36 can press the wire 3 against the clamping surface 48 of the bracket 2. In some embodiments, the clamping surface 48 can have a curvature complementary to that of the wire 3. In some embodiments, the tapered wedge surface 36 may also have a curvature complementary to the curvature of the wire 3. In the locked mode, the wedge surface 36 may be disposed vertically between the wire and the retention surface of the bracket 2.

As with the embodiment of FIGS. 2A-2O, the locking assembly 5 of FIGS. 3A-3E in the locked mode can apply a sufficiently large force against the wire 3 to prevent sliding of the wire 3 relative to the bracket 2 when subject to typical orthodontic forces. In various embodiments, for example, the locking assembly 5 can exert frictional forces in the locked and sliding modes in a manner and with relative magnitudes as described above in connection with FIGS. 2A-2O.

FIGS. 4A-4D illustrate an orthodontic device 1 that includes a bracket 2 and a locking assembly 5 mechanically connected to the bracket 2, according to another embodiment. Unless otherwise noted, the components of FIGS. 4A-4D may be the same as or generally similar to like-numbered components of FIGS. 1A-3E, and may function or operate in a generally similar manner. For example, as with FIGS. 2A-3E, the locking assembly 5 can include a clip 6 and wedge member 7 that cooperate with one another and with the bracket 2 to provide an open mode, a sliding support mode, and a locked support mode. In particular, FIG. 4A is a front, top, right side perspective view of the orthodontic device 1. FIG. 4B is a schematic side sectional view of the orthodontic device 1 of FIG. 4A in an open mode. FIG. 4C is a schematic side sectional view of the orthodontic device 1 of FIG. 4A in a sliding mode. FIG. 4D is a schematic side sectional view of the orthodontic device 1 of FIG. 4A in a locked mode.

The device 1 of FIGS. 4A-4D and its components can be combined with any suitable features of the embodiments of FIGS. 2A-3E, and may be positioned on any suitable surface of the tooth 10 to be treated (for example, a lingual surface, or a buccal or labial surface). The device 1 may also be oriented relative to the tooth 10 in any suitable manner (for example, with the front side facing gingivally or occlusally). Unlike the embodiments of FIGS. 2A-3E, however, the wedge member 7 can cooperate with a clamping surface that comprises the retention surface 26 at the floor of the retention cavity 24 of the bracket 2 to lock the wire 3 in the locked mode. The wedge member 7 can be positioned vertically above the wire 3 such that, in a locked mode, the wire 3 can be disposed between the wedge member 7 and the retention surface 26 of the bracket 2. In the locked mode, the wedge member 7 can be positioned vertically between the clip 6 and the wire 3. Further, unlike the embodiment of FIGS. 3A-3D, the wedge surface 36 can be disposed at a middle portion of the wedge member 7, rather than at a front end. Moreover, the wedge surface 36 that contacts the wire 3 in the locked mode may or may not be tapered or angled. In some embodiments, the wedge surface 36 can be generally planar along the transverse axis y. In addition, the wedge member 7 can include a tapered front surface 49 at a front end of the wedge member 7. The tapered front surface 49 can be generally angled or tapered downwardly and rearwardly from the front end of the wedge member 7 along a lower surface of the wedge member 7.

As shown in FIG. 4B, in the open mode, the clip 6 can be moved or kept in a forward or front position to expose the retention cavity 24. The wedge member 7 can be moved or kept in a rear position. In FIG. 4B, the clip 6 and the wedge member 7 can move along directions non-parallel to each other. For example, while the clip 6 can move along a first direction 600, the wedge member 7 can move along a second direction 700 non-parallel to the first direction 600. The wire 3 can be inserted into the retention cavity 24 and onto the retention surface 26. In FIG. 4C, the clip 6 can be moved to a rear position, and the wedge member 7 can be moved to a first forward or front position to place the device 1 in a sliding mode. As shown, in the first forward position, the tapered front surface 49 of the wedge member 7 can mate or engage with the front wall 23a of the bracket 2 in the sliding mode. In the sliding mode, the tapered front surface 49 may provide a clearance or gap between the wedge member 7 and the wire 3 to permit passive or active ligation in the sliding mode. In the sliding mode, the clamping surface 36 may not be exposed to the retention cavity 24 but may instead remain in the transverse cavity 25. Turning to FIG. 4D, the device 1 can be moved to the locked mode by translating the wedge member 7 forward to a second forward or front position that is forward of the first front position. In the second forward position of the locked mode, the wedge surface 36, which can project or extend downwardly relative to the tapered front surface 49, can press the wire 3 against the retention surface 26 of the bracket 2.

As with the embodiment of FIGS. 2A-3E, the locking assembly 5 of FIGS. 4A-4D in the locked mode can apply a sufficiently large force against the wire 3 to prevent sliding of the wire 3 relative to the bracket 2 when subject to typical orthodontic forces. In various embodiments, for example, the locking assembly 5 of FIGS. 4A-4D can exert frictional forces in the locked and sliding modes in a manner and with relative magnitudes as described above in connection with FIGS. 2A-2O.

FIGS. 5A-5D illustrate an orthodontic device 1 that includes a bracket 2 and a locking assembly 5 mechanically connected to the bracket 2, according to another embodiment. Unless otherwise noted, the components of FIGS. 5A-5D may be the same as or generally similar to like-numbered components of FIGS. 1A-4D, and may function or operate in a generally similar manner. For example, as with FIGS. 2A-4D, the locking assembly 5 can include a clip 6 and wedge member 7 that cooperate with one another and with the bracket 2 to provide an open mode, a sliding support mode, and a locked support mode. In particular, FIG. 5A is a front, top, right side perspective view of the orthodontic device 1. FIG. 5B is a schematic side sectional view of the orthodontic device 1 of FIG. 5A in an open mode. FIG. 5C is a schematic side sectional view of the orthodontic device 1 of FIG. 5A in a sliding mode. FIG. 5D is a schematic side sectional view of the orthodontic device 1 of FIG. 5A in a locked mode.

The device 1 of FIGS. 5A-5D and its components can be combined with any suitable features of the embodiments of FIGS. 2A-4D, and may be positioned on any suitable surface of the tooth 10 to be treated (for example, a lingual surface, or a buccal or labial surface). The device 1 may also be oriented relative to the tooth 10 in any suitable manner (for example, with the front side facing gingivally or occlusally). As with the embodiment of FIGS. 4A-4D, the wedge member 7 can cooperate with a clamping surface that comprises the retention surface 26 at the floor of the retention cavity 24 of the bracket 2 to lock the wire 3 in the locked mode. The wedge member 7 can be positioned vertically above the wire 3 such that, in a locked mode, the wire 3 can be disposed between the wedge member 7 and the retention surface 26 of the bracket 2. Further, as with the embodiment of FIGS. 4A-4D, the wedge surface 36 can be disposed at a middle portion of the wedge member 7, rather than at a front end. Moreover, the wedge surface 36 that contacts the wire 3 in the locked mode may or may not be tapered or angled. In some embodiments, the wedge surface 36 can be generally planar along the transverse axis y. Unlike the embodiment of FIGS. 4A-4D, however, the wedge member 7 be inserted through a transverse cavity 25 that extends rearwardly at least partially through the clip 6 and at least partially through a portion of the bracket 2. In some embodiments, the transverse cavity 25 extends entirely through both the bracket 2 and the clip 6. In other embodiments, the transverse cavity 25 extends only partially through one or both the bracket 2 and the clip 6. In addition, the wedge member 7 can include a tapered rear surface 49′ at a rear end of the wedge member 7. The tapered rear surface 49′ can be generally angled or tapered upwardly and rearwardly from the front end of the wedge member 7 along a lower surface of the wedge member 7.

As shown in FIG. 5B, in the open mode, the clip 6 and the wedge member 7 can be moved or kept in a forward or front position to expose the retention cavity 24. The wire 3 can be inserted into the retention cavity 24 and onto the retention surface 26. In FIG. 5C, the clip 6 can be moved to a rear position, and the wedge member 7 can be moved to a first rear position to place the device 1 in a sliding mode. As shown, in the first rear position, the tapered rear surface 49′ of the wedge member 7 can mate or engage with the rear wall 23b of the bracket 2 in the sliding mode, and can partially extend into a portion of the transverse cavity 25 formed through the rear wall 23b. In the sliding mode, the tapered rear surface 49′ may provide a clearance or gap between the wedge member 7 and the wire 3 to permit passive or active ligation in the sliding mode. In the sliding mode, the clamping surface 36 may not be exposed to the retention cavity 24 but may instead remain in the transverse cavity 25. Turning to FIG. 5D, the device 1 can be moved to the locked mode by translating the wedge member 7 rearward to a second rear position that is rearward of the first rear position. In the second rear position of the locked mode, the wedge surface 36, which can project or extend downwardly relative to the tapered rear surface 49′, can press the wire 3 against the retention surface 26 of the bracket 2.

As with the embodiment of FIGS. 2A-4D, the locking assembly 5 of FIGS. 5A-5D in the locked mode can apply a sufficiently large force against the wire 3 to prevent sliding of the wire 3 relative to the bracket 2 when subject to typical orthodontic forces. In various embodiments, for example, the locking assembly 5 of FIGS. 5A-5D can exert frictional forces in the locked and sliding modes in a manner and with relative magnitudes as described above in connection with FIGS. 2A-2O.

### B. Additional Examples of Orthodontic Devices

In various embodiments, the bracket 2, the wire 3, the clip 6, and the wedge member 7 can each move along different directions allowing various positioning of orthodontic devices on teeth of different shapes and in different arrangements. For example, on a certain tooth, it may be clinically desirable to have the wire 3 non-parallel to a bottom side of the device 1 and/or the surface of the tooth. In other embodiments, it may be clinically desirable for the wedge member 7 and the clip 6 to move in axes non-parallel to each other to apply a certain force or range of forces to the wire 3.

As shown in FIGS. 6A-6B, in some embodiments, the device 1 can include the bracket 2, the wire 3, the clip 6, and the wedge member 7 in a similar manner as the embodiment in FIGS. 2A-2B. FIG. 6A is a front, top, right side perspective view of the orthodontic device 1, according to an embodiment different from that in FIGS. 2A-2B. FIG. 6B is a front, top, right side perspective view of the orthodontic device 1 of FIG. 6A. FIG. 6C is a schematic front, top, right side perspective view of the wedge member 7 of the device 1 in FIGS. 6A-6B. FIG. 6D is a schematic front, top, right side perspective view of the clip 6 used in the device 1 in FIGS. 6A-6B. FIG. 6E is a schematic front, top, right side perspective view of the bracket 2 used in the device 1 in FIGS. 6A-6B. FIG. 6F is a schematic top plan view of the bracket 2 in FIG. 6E. FIG. 6G is a schematic top plan view of the orthodontic device 1 in FIGS. 6A-6B in a sliding support mode. FIG. 6H is a schematic top plan view of the orthodontic device 1 in FIGS. 6A-6B in a locked support mode.

As shown in FIGS. 6A-6H, in accordance with various embodiments, the device 1 and one or more of its components including the bracket 2, the wire 3, the clip 6, and the wedge member 7 can be distorted or angled compared to the embodiment illustrated in FIG. 2A-2B. For example, FIGS. 6A-6B shows that the wire 3 can extend along a lateral axis x. The base 22 of the bracket 2 can have two parallel and opposite sides, 221 and 223. The lateral axis x can be non-parallel to the sides 221 and 223. FIG. 6C shows that the tapered wedge surface 36 of the wedge member 7 can be skewed relative to the raised rear portion 39. FIG. 6E shows that the retention cavity 24 can extend along the lateral axis x to receive the wire 3.

FIG. 6F shows that the bracket 2 can be distorted laterally in the transverse plane xy to accommodate angled movements of the components, wire 3, the clip 6 and the wedge member 7, as illustrated in FIG. 6G. The base 22 of the bracket 2 in FIG. 6F-6H can have adjacent and connecting sides, 221 and 222, that are at a non-orthogonal angle relative to each other. FIGS. 6G and 6H shows that the wedge member 7 can move along an axis 700 which is angled from the transverse axis y of the device 1, and the clip 6 can move along an axis 600 angled from the transverse axis y. In accordance with various embodiments, the axis 700, along which the wedge member 7 moves, and the axis 600, along which the clip 6 moves, can be non-parallel to each other. In other embodiments, however, the axis 700 and the axis 600 can instead be parallel to each other even though the sides 221, 222 are skewed relative to one another.

FIG. 7 gives another top plan view of a different embodiment of the device 1 showing the movement of the clip 6 and the that of the wedge member 7. The base 22 of the bracket 2 in FIG. 7 can similarly have adjacent and connecting sides 221 and 222 that are at a non-orthogonal angle relative to each other. In certain embodiments, the wedge member 7 can move along an axis 700 that is at a greater angle relative to the transverse axis y than relative to the lateral axis x, while the clip 6 moves along the axis 600 that is only slightly angled from the transverse axis y.

In FIG. 7, the axis 700, along which the wedge member 7 moves, can be angled from the axis 600, along which the clip 6 moves, in the transverse plane xy. In other embodiments as shown in FIG. 8, the axis 700, along which the wedge member 7 moves, can be angled from the axis 600, along which the clip 6 moves, in the vertical plane yz. FIG. 8 shows a side sectional view of yet another embodiment of the device 1 in a locked support mode. As shown in FIG. 8, in accordance with various embodiments, the wedge member 7 can be further angled in the vertical plane yz along the axis 700 at an angle from the transverse axis y. In accordance with various embodiments in FIGS. 7 and 8, the wedge member 7 and the clip 6 can move non-parallel to each other.

FIG. 9A is a back, right perspective view of another embodiment of the device 1 without the clip 6 showing that the wire 3 can extend along a lateral axis x angled relative to the bottom side 35 of the device 1. FIG. 9B shows the lateral axis x is angled relative to the bottom side 35 of the device 1 in a front sectional view of the device 1 of FIG. 9A.

In various embodiments, it can be clinically desirable to angle or distort one or more components of the device 1 in a plane or from an axis different from that of the embodiments disclosed above. In other embodiments, it may be clinically desirable to angle or distort a portion of the device 1 while keeping the other portion aligned with the lateral, transverse, and vertical axes of the device 1. For example, FIG. 10 is a schematic back plan view of another embodiment of the device 1 having a bracket 2 that is tilted from the bottom side 35 of the device 1. In cooperation with the bracket 2, the wedge member 7 and the wire 3 in FIG. 10 can also be tilted in the lateral plane xz at angle relative to the bottom side 35. In yet another embodiment shown in FIG. 11, the wire 3 can extend along the lateral axis x that is angled relative to the two opposite and parallel sides 221 and 223 of the base 22 of the device 1. In accordance with various embodiments in FIG. 9A-11, the wedge member 7 and the clip 6 can move non-parallel to each other; and in other embodiments, the wedge member 7 and the clip 6 can also move parallel to each other.

### III. CONCLUSION

Although the tooth 10 schematically depicted in some of the figures is a molar, the procedures and devices disclosed herein may be performed on or applied to any type of tooth such as an incisor, a canine, a bicuspid, a pre-molar, or a molar. Further, although the tooth may be depicted as a lower (mandibular) tooth in the figures, this is for purposes of illustration, and is not limiting. The devices and methods may be applied to lower (mandibular) teeth or upper (maxillary) teeth. Also, the disclosed devices and methods can be applied to lingual and/or facial (e.g., labial or buccal) surfaces of the tooth 10. Moreover, the disclosed apparatus, methods, and compositions may be applied to human teeth (including juvenile teeth) and/or to animal teeth.

Reference throughout this specification to “some embodiments” or “an embodiment” means that a particular feature, structure, element, act, or characteristic described in connection with the embodiment is included in at least one embodiment. Thus, appearances of the phrases “in some embodiments” or “in an embodiment” in various places throughout this specification are not necessarily all referring to the same embodiment and may refer to one or more of the same or different embodiments. Furthermore, the particular features, structures, elements, acts, or characteristics may be combined in any suitable manner (including differently than shown or described) in other embodiments. Further, in various embodiments, features, structures, elements, acts, or characteristics can be combined, merged, rearranged, reordered, or left out altogether. Thus, no single feature, structure, element, act, or characteristic or group of features, structures, elements, acts, or characteristics is necessary or required for each embodiment. All possible combinations and subcombinations are intended to fall within the scope of this disclosure.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

The foregoing description sets forth various example embodiments and other illustrative, but non-limiting, embodiments of the inventions disclosed herein. The description provides details regarding combinations, modes, and uses of the disclosed inventions. Other variations, combinations, modifications, equivalents, modes, uses, implementations, and/or applications of the disclosed features and aspects of the embodiments are also within the scope of this disclosure, including those that become apparent to those of skill in the art upon reading this specification. Additionally, certain objects and advantages of the inventions are described herein. It is to be understood that not necessarily all such objects or advantages may be achieved in any particular embodiment. Thus, for example, those skilled in the art will recognize that the inventions may be embodied or carried out in a manner that achieves or optimizes one advantage or group of advantages as taught herein without necessarily achieving other objects or advantages as may be taught or suggested herein. Also, in any method or process disclosed herein, the acts or operations making up the method or process may be performed in any suitable sequence and are not necessarily limited to any particular disclosed sequence.

1. An orthodontic device comprising:
a bracket having a retention cavity sized and shaped to receive and support an orthodontic wire;
a clip to be coupled to the bracket and to be positioned over the orthodontic wire in use, the clip configured to move along a first direction to retain the orthodontic wire in the retention cavity; and
a wedge member to be coupled to the bracket, the wedge member configured to move along a second direction, the second direction non-parallel relative to the first direction; and
a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces,

2. The orthodontic device of claim 1, wherein the orthodontic wire is to be disposed between the wedge member and the clip with the wedge member disposed between the orthodontic wire and the bracket, the wedge member including a tapered wedge surface that engages the orthodontic wire.

3. (canceled)

4. (canceled)

5. (canceled)

6. The orthodontic device of claim 1 wherein the frictional adjustment mechanism is configured to exert a non-sliding force against the orthodontic wire to prevent sliding that is at least 50 cN.

7. (canceled)

8. The orthodontic device of claim 1 wherein the wedge member includes one or a plurality of tooling apertures sized to receive a tool to adjust the frictional force against the orthodontic wire.

9. The orthodontic device of claim 1, wherein the frictional adjustment mechanism comprises the clip and the wedge member that cooperate to exert the adjustable frictional force against the orthodontic wire.

10. (canceled)

11. The orthodontic device of claim 9, wherein, in use, the orthodontic wire is to be disposed between the bracket and the wedge member, the wedge member disposed between the wire and the clip.

12. The orthodontic device of claim 9, wherein the wedge member includes a tapered wedge surface that engages the orthodontic wire, the wedge member having a thickness varying along at least a portion of the length of the wedge member.

13. The orthodontic device of claim 1, wherein the clip, the wedge member, and the bracket are configured to cooperate to exert the adjustable frictional force against the orthodontic wire;
wherein the retention cavity extends along a lateral axis of the orthodontic device, the orthodontic device having a transverse axis perpendicular to the lateral axis; and
wherein the wedge member has a tapered wedge surface angled relative to a vertical axis that is non-parallel relative to the lateral axis and the transverse axis, the wedge member having a thickness in the direction of the vertical axis and a length in the direction of the transverse axis, the thickness varying along at least a portion of the length of the wedge member.

14. The orthodontic device of claim 13, wherein the clip, the wedge member, and the bracket are configured to cooperate to move between a plurality of operational modes, the plurality of operational modes comprises a first sliding mode in which the orthodontic wire is slidable relative to the bracket and a second locked mode in which the orthodontic wire is slidably locked relative to the bracket.

15. (canceled)

16. The orthodontic device of claim 14, wherein the wedge member in the sliding mode is disposed at a first position, and wherein the wedge member in the second locked mode is disposed at a second position that is different from the first position.

17. The orthodontic device of claim 16, wherein in the second locked mode, the tapered wedge surface of the wedge member contacts and exerts a locking force against the orthodontic wire.

18. (canceled)

19. (canceled)

20. An orthodontic device comprising:
a bracket having a retention cavity sized and shaped to receive and support an orthodontic wire, the retention cavity extending along a lateral axis of the orthodontic device, the orthodontic device having a transverse axis perpendicular to the lateral axis and a vertical axis perpendicular to the lateral and transverse axes;
a clip to be coupled to the bracket and to be positioned over the orthodontic wire in use, the clip configured to move along a first direction at a first angle relative to the transverse axis of the orthodontic device to retain the orthodontic wire in the retention cavity; and
a wedge member to be coupled to the bracket, the wedge member configured to move along a second direction at a second angle relative to the transverse axis, the second angle different from the first angle; and
a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

21. (canceled)

22. (canceled)

23. The orthodontic device of claim 20, wherein the orthodontic wire is to be disposed between the wedge member and the clip with the wedge member disposed between the orthodontic wire and the bracket, the wedge member including a tapered wedge surface that engages the orthodontic wire.

24. The orthodontic device of claim 20, wherein the frictional adjustment mechanism is adjustable to apply a continuously variable frictional force against the orthodontic wire.

25. (canceled)

26. (canceled)

27. (canceled)

28. (canceled)

29. (canceled)

30. (canceled)

31. (canceled)

32. (canceled)

33. (canceled)

34. The orthodontic device of claim 20, wherein the clip, the wedge member, and the bracket are configured to cooperate to exert the adjustable frictional force against the orthodontic wire;
wherein the wedge member has a tapered wedge surface angled relative to a vertical axis that is non-parallel relative to the lateral axis and the transverse axis, the wedge member having a thickness in the direction of the vertical axis and a length in the direction of the transverse axis, the thickness varying along at least a portion of the length of the wedge member.

35. The orthodontic device of claim 34, wherein the clip, the wedge member, and the bracket are configured to cooperate to move between a plurality of operational modes, the plurality of operational modes comprises a first sliding mode in which the orthodontic wire is slidable relative to the bracket and a second locked mode in which the orthodontic wire is slidably locked relative to the bracket.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. An orthodontic device comprising:
a bracket having a retention cavity sized and shaped to receive and support an orthodontic wire, the bracket having a base portion to be attached to a tooth to be treated, the base portion having first and second connecting side edges disposed at a non-orthogonal angle relative to one another;
a clip to be coupled to the bracket and to be positioned over the orthodontic wire in use, the clip configured to move along a first direction to retain the orthodontic wire in the retention cavity; and
a wedge member to be coupled to the bracket, the wedge member configured to move along a second direction; and
a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

53. The orthodontic device of claim 52, wherein the first direction is non-parallel to the second direction.

54. An orthodontic device comprising:
a bracket having a retention cavity sized and shaped to receive and support an orthodontic wire, the retention cavity extending along a lateral axis of the orthodontic device, the bracket having a base portion to be attached to a tooth to be treated along an attachment surface, the lateral axis non-parallel with the attachment surface;
a clip to be coupled to the bracket and to be positioned over the orthodontic wire in use, the clip configured to move along a first direction to retain the orthodontic wire in the retention cavity; and
a wedge member to be coupled to the bracket, the wedge member configured to move along a second direction; and
a frictional adjustment mechanism comprising at least the wedge member, the frictional adjustment mechanism configured to exert an adjustable frictional force against the orthodontic wire, including a range of sliding frictional forces in which the orthodontic wire is slidable relative to the bracket and at least one non-sliding frictional force that prevents sliding of the orthodontic wire in use when the orthodontic wire is subject to typical orthodontic forces.

55. The orthodontic device of claim 54, wherein the first direction is non-parallel to the second direction.
